(19) United States
(12) Patent Application Publication
(10) Pub. No.: US 2015/0010069 A1
(43) Pub. Date: Jan. 8, 2015

(54) Intra video coding in error prone environments

(71) Applicant: CANON KABUSHIKI KAISHA, Tokyo (JP)

(72) Inventors: ROMAIN GUIGNARD, RENNES (FR); STÉPHANE BARON, LE RHEU (FR)

(21) Appl. No.: 14/320,262

(22) Filed: Jun. 30, 2014

(30) Foreign Application Priority Data
Jul. 2, 2013 (GB) 1311843.5

(51) Int. Cl. H04N 19/593

(52) U.S. Cl. CPC H04N 19/00763
USPC 375/240.12

(57) ABSTRACT

A method of processing data for video encoding, comprising the following steps:
obtaining a current coding entity of a current video frame to encode, said current frame to encode being segmented according to a plurality of coding entities, each coding entity comprising a plurality of coding units, and for a current coding unit of the current coding entity obtained:
determining whether there are neighbouring pixels outside the current coding entity that can be used for generating an outside coding unit predictor for predicting said current coding unit,
enabling, based on a result of said determining step, use of neighbouring pixels outside the current coding entity, for generating at least one outside coding unit predictor for predicting the current coding unit, and
selecting, using at least one weighting criterion applied to the at least one outside coding unit predictor, a coding unit predictor among a default coding unit and the at least one outside coding unit predictor.

Embodiments of the invention provide a good trade-off between reducing error propagation and keeping good compression efficiency.

### PRIORITY CLAIM/INCORPORATION BY REFERENCE

This application claims the benefit under 35 U.S.C. §119(a)-(d) of United Kingdom Patent Application No. 1311843.5, filed on 2 Jul. 2013 and entitled “Intra video coding in error prone environments”. The above cited patent application is incorporated herein by reference in its entirety.

### FIELD OF THE INVENTION

The present invention relates to video streaming over communication networks.

More particularly, the present invention relates to video streaming implementing dynamic modification of the size of slices segmenting video frames in order adapt to the available bandwidth.

### BACKGROUND OF THE INVENTION

Multimedia data transmission, especially over wireless networks, requires low latency. Also, the constant increase of video definition requires more and more data processing resources (such as memory, CPU power, bandwidth etc.).

In order to meet such requirements, codecs have been developed such as H264, HEVC. Such codecs provide reduced bandwidth with a good level of quality.

However, the codecs developed so far need adaptation to be implemented on portable devices (smartphones, cameras etc.). Portable devices have reduced CPU power and low energy consumption requirements, especially for coding video data. Also, memory space is limited on portable devices. For instance, H264 codecs require that several consecutive images to be kept in memory in order to perform efficient prediction. In case of high definition images, the amount of (high speed) memory needed may not be compatible with the memory available on portable devices.

New generation codecs, adapted to meet the low resources requirements of the portable devices have been developed. Such codecs are based on intra frame prediction and make it possible to store in memory only a reduced part of the images (for example a small number of lines of pixels) thereby reducing the encoding process complexity.

For example, “line based codecs” divide (or segment) the video frames to be encoded into a number of parts referred to as “slices”. Then, in the case of an “intra only” codec (such as the H264 intra codec), each slice is encoded without any reference to previous slices in the frame, or any reference to previous frames.

As far as “inter frame” prediction is concerned, even though it makes it possible to increase the compression rate, it is not used because it may increase error propagation. For example, when a part of the image to encode is lost (due to bad network conditions for example) a decoding error occurs that cannot be fully recovered since the error is part of the data used as the basis for the prediction mechanism.

Line based intra codecs have the advantage of reducing the memory required because they do not require storing previous data in order to encode the current ones.

In order to finely adapt the throughput of the codecs to the unpredictable wireless conditions while keeping a constant image quality, rate control may be performed in the case of line based codecs by dynamically adapting the size of each slice segmenting the video frames to encode. The size of the slices may be defined by the number of macroblocks in the slices.

However, problems may occur when slices are spread over consecutive lines of macroblocks.

Each macroblock is encoded using the difference between the current macroblock and a macroblock predictor obtained from already encoded macroblocks of the same slice. In order to find similar macroblocks, thereby increasing compression efficiency, macroblock predictor candidates are defined based on already encoded neighbouring macroblocks localized in the vicinity of the macroblock to encode. Macroblocks of other slices of the same image cannot be used.

For instance, the H264 codec defines 13 positions with respect to a current macroblock to encode for selecting predictor macroblock candidates. The positions are referred to as “prediction modes”. There are defined 9 positions for the 4×4 macroblocks (8 directions, plus the DC macroblock used as reference and which is an average macroblock) and 4 positions for the 16×16 macroblocks (3 directions, plus the DC macroblock used as reference). In case no encoded macroblock can be found in the vicinity of the macroblock to encode, a pre-defined or default DC macroblock is used as the predictor.

At the beginning of each slice, there is no encoded macroblock available (no macroblock has been encoded in the slice). Thus, the use of the pre-defined DC macroblock as a predictor is necessary for the first macroblocks of the slices. However, the use of the pre-defined DC macroblock as predictor for the other macroblocks is not encouraged in the prior art since there may be a large difference between the current macroblock to encode and the pre-defined DC macroblock, which decreases the compression rate.

Therefore, when a slice is spread over one or more lines of macroblocks, a loss of efficiency in the encoding process may occur when the number of macroblocks having no pixels in their neighbourhood for generating predictors is increased.

Thus, use of encoded macroblocks outside the current slice as predictors may still be needed.

The use of predictors outside the current slice is not allowed in the H264 codec (wherein each slice must be “self-decodable”, i.e. without any reference to a previous slice).

With the concept of dependent slice segment, the HEVC codec provides an intermediate solution between the solution adopted with the H.264 standard and the solution authorizing the use of pixels of other slices for the intra prediction in one slice. According to the HEVC codec, slices are now defined as a set of slice segments comprising at least one independent slice segment and optionally dependent slice segments. A slice may contain only one independent slice segment and the introduction of one independent slice segment induces the creation of a new slice. The dependent slice segments do not break the entropy coding dependencies and the prediction over the slice segment boundaries. Therefore, during the prediction phase, the encoder can take a macroblock outside the current slice segment as a predictor despite the slice segment boundaries.

However, this mechanism creates dependencies in between slice segments which may be tolerated when the transmission is error free.

In the context of a wireless transmission (for instance, an ad-hoc wireless LAN), this cannot be tolerated due to several factors such as, e.g., the limit of range in between nodes, the perturbation of other devices using the same communication channels etc. Wireless transmissions generally have high bit error rates.

Moreover, the bit error rate problem may be made worse by the MAC layer mechanisms (802.11n and later 802.11ac). In order to improve the maximum throughput available for the transmission and keep the compatibility with previous 802.11 version (b,g), the 802.11n MAC layer (and later 802.11 ac) uses a mechanism of aggregation which aggregates several MAC packets (MSDU) provided by the application into one unique physical packet (PDU) that is sent over the network.

The aggregation mechanism reduces the overhead due to packet header insertion and the impact of the delay which distinguishes two successive frames. However, the aggregation mechanism when coupled with the MAC error detection process (according to which the 802.11 MAC layer discards the packets when an error is detected, for example a CRC error), has negative effects on the loss rate. For a given bit error rate measured at the physical layer, the packet loss rate is higher when using the aggregation mechanism, because several aggregated packets are lost at one time. Hence, the dependencies in between slice segments introduced by the HEVC dependent slice segments can have drawbacks on the quality in case of transmission errors.

There is thus a need for avoiding error propagation introduced by the use of dependent slice segments, in particular in error prone networks, such as wireless networks.

The error propagation problem is known for the “inter coding” (i.e. temporal dependency between frames). The encoder selects the best predictor among a pool of previous frames.

Several mechanisms can limit the negative effects of temporal dependencies. For example, an acknowledgement mechanism may be combined with a retransmission mechanism: the erroneous packets are retransmitted to the receiver. Also, the encoder may select the reference picture to use as a predictor among the error free pictures. Another mechanism may consist in periodically encoding the macro-blocks in intra mode in order to stop the error propagation (“Intra Refresh” mechanism).

However, these mechanisms are mainly based on feedback from the receiver which is possible for temporal dependencies, but which cannot be used because of the close spatial position of the dependent slice segments. Indeed, the time between two successive frames for a video of 60 frames per second is 16 milliseconds, whereas the time between two successive slices is around 200 microseconds for instance for a slice size around a line of macroblock. Therefore, the dependent slices could be transmitted in the same physical packet or already encoded when an acknowledgement arrives and the acknowledgement could not be used to modify or influence the encoding process.

Other techniques are based on the selection of the prediction mode and the quantification parameter value by taking into account the network error statistics and the distortion due to errors in the video data. Other intra-refresh techniques are based on the inter-frame dependency history which describes the use of the dependency history for each pixel through the successive reference frame in order to minimize the error propagation.

However, these techniques are not well adapted to the dependencies between intra slices and/or are not optimal in terms of computing complexity.

### SUMMARY OF THE INVENTION

In fact, there is a need for solving the problem of error propagation introduced by the dependent slice segments in error prone environments.

The present invention lies within this context.

According to a first aspect of the invention, there is provided a method of processing data for video encoding, the method comprising the following steps:
obtaining a current coding entity of a current video frame to encode, said current frame to encode being segmented according to a plurality of coding entities, each coding entity comprising a plurality of coding units, and
   for a current coding unit of the current coding entity obtained:
determining whether there are neighbouring pixels outside the current coding entity that can be used for generating an outside coding unit predictor for predicting said current coding unit,
enabling, based on a result of said determining step, use of neighbouring pixels outside the current coding entity, for generating at least one outside coding unit predictor for predicting the current coding unit, and
selecting, using at least one weighting criterion applied to the at least one outside coding unit predictor, a coding unit predictor among a default coding unit and the at least one outside coding unit predictor.

For example, the coding entity may be a slice segment. The coding units may be macroblocks of pixels.

The method according to the first aspect makes it possible to reduce error propagation even when using intra coding or dependent slice segments.

Methods according to the first aspect are compliant with the HEVC standard. However, the invention is not limited to this standard and proprietary adaptations are may be envisaged (for instance adaptations to H.264).

Use of predictors outside a current coding entity may be enabled or not, based on an assessment of a risk of error propagation in the prediction chain between dependent slices.

Thus, the weighting criterion may be based on a risk of propagating errors using an outside coding unit predictor as a predictor for the current coding unit.

The weighting criterion may be based on at least one of:
a dependency chain length measuring successive dependencies between coding entities for the current coding entity,
transmission conditions in a network to be used for transmitting the current coding entity,
a length of the current coding entity after the current coding unit,
a length of the current coding entity, and
a comparison value, measuring a difference between the current coding unit and said default coding unit.

Such elements make it possible to assess the risk of error propagation accurately.

The method may further comprise the following steps:
computing for each coding unit of the coding entities of the current video frame, a dependency parameter value, said dependency parameter representing a risk of error propagation induced by the use of outside coding unit predictors for each coding units, and
for each coding unit, deciding, based on said value, to discard use of outside coding units as predictors for each coding unit.

For example, said dependency parameter value may be updated, based on whether a default coding unit or an outside coding unit predictor is used as a predictor for the current coding unit.

The method may further comprise an initialization step for initializing the dependency parameters for the coding units of the coding entities of the current frame.

For example, the initializing step comprises:
determining whether the current coding unit and a neighbouring pixels outside the current coding entity belong to respective distinct transmission packets, and
setting the dependency parameter of a current coding unit to a maximum initial value indicating that error propagation in case of use of said outside coding unit as a predictor for the current coding unit is high.

According to another example, the initializing step comprises:
determining whether the current coding unit and an outside coding unit belong to separate transmission packets,
determining whether a length of the current coding entity after the current coding unit is above a first threshold, and
setting the dependency parameter of a current coding unit to an intermediate initial value indicating that error propagation in case of use of said outside coding unit as predictor for the current coding unit is average.

The initializing step may further comprise:
determining whether a length of the current coding entity is above a second threshold, and
setting the dependency parameter of a current coding unit to an intermediate initial value indicating that error propagation in case of use of said outside coding unit as a predictor for the current coding unit is average.

According to another example, the initializing step comprises:
determining whether the current coding unit is a first coding unit in a set of coding units having adjoining relations, and
setting the dependency parameter of a current coding unit to a minimum initial value indicating that error propagation in case of use of said outside coding unit as a predictor for the current coding unit is low.

For example, the set of coding units having adjoining relations may comprise coding units not having any neighbouring pixels of the same coding entity to use for generating a predictor. The first coding unit in this set may be the first one in the order of the coding units in the frame.

According to embodiments, the method further comprises the following steps, performed for each coding unit of the coding entities of the current video frame:
comparing a first difference between the current coding unit and said default coding unit with at least one second difference between the current coding unit and an outside coding unit predictor, and
computing a favour parameter value, said favour parameter indicating whether an outside coding unit may be used as a better predictor than the default coding unit, based on said comparing step.

For example, the method further comprises a step of filtering coding units according to their respective favour parameter values, and wherein the initialization step is performed for coding units for which an outside coding unit may be used as a better predictor than the default coding unit.

According to embodiments, the method may further comprise a step of generating a list of coding units of the frame to encode, the coding units of the list not having any neighbouring pixels of the same coding entity to use for generating a predictor, and wherein the step of determining whether an outside coding unit of the current coding entity can be used as a predictor is based on said list.

For example, said list comprises, for each coding unit of the list at least one of:
a length of the current coding entity after the current coding unit,
a length of the current coding entity,
a comparison value, measuring a difference between the current coding unit and said default coding unit,
a dependency parameter value, and
a favour value.

According to embodiments, the method further comprises determining a type of the current coding entity, based on the coding unit predictors selected for predicting the coding units of the current coding entity.

For example, the current coding entity is a slice segment, said slice segment being of the independent type in case no coding unit of the slice segment is predicted by an outside coding unit predictor.

According to a second aspect of the invention, there is provided an encoding device configured for implementing a method according to the first aspect.

According to a third aspect of the invention, there is provided a system comprising a plurality of encoding devices configured for communicating over a communication network (i.e. a wireless network). For example, the encoding devices stream video data to display devices of the network.

### BRIEF DESCRIPTION OF THE DRAWINGS

Other features and advantages of the invention will become apparent from the following description of non-limiting exemplary embodiments, with reference to the appended drawings, in which:

FIG. 1 illustrates an exemplary context of implementation of embodiments of the invention;

FIG. 2 illustrates a device according to embodiments;

FIGS. 3a and 3b illustrate slicing according to embodiments;

FIGS. 4a-4d illustrate slicing adaptation according to embodiments;

FIG. 5 illustrates results of a slice adaptation;

FIGS. 6a and 6b illustrate selection of macroblocks that may use predictors outside the slice segment to which they belong;

FIG. 7 is a flowchart of an exemplary computation of the initial value for the limiting factor;

FIG. 8 is an illustration of the macroblocks of FIG. 6a using outside predictors during the encoding process;

FIG. 9 is a flowchart of an exemplary selection of the macroblocks for which an outside predictor may be used;

FIG. 10 is a flowchart of steps of an exemplary encoding method;

FIGS. 11a-11e illustrate the prediction directions for the 4×4 blocks as described in the H264 standard.

### DETAILED DESCRIPTION OF THE INVENTION

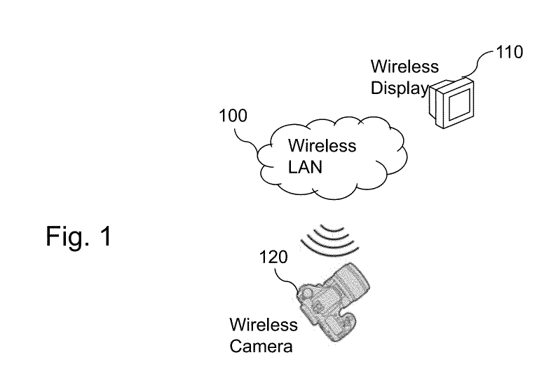

An exemplary context of implementation of embodiments of the invention is described with reference to FIG. 1.

An encoding device, e.g. a camera 120 encodes video data in order to stream the encoded video data to a display device 110 via a network 100. For example, the network is a wireless LAN. The encoding device 120 is configured to implement a line codec. For example, each slice of the frames of the video data is encoded as a standalone decodable unit. Such codec provides both a low latency and avoids error propagation in video frames.

In order to be able to finely adapt the throughput of the video codec to the network conditions, the rate control of the codec implemented by the encoding device may adapt the size of each slice or slice segment according to the network conditions (such as the available bandwidth for instance).

In what follows, the example of the HEVC standard codec is used, with reference to the dependent slice segment concept. Embodiments of the invention may be implemented in the context of the HEVC standard. However, the invention is not limited to the standard. For example the H264 video standard may be implemented. When implementing the H264 video standard, since the concept of slice segment is not available, inter slice intra prediction may be authorized as a proprietary solution.

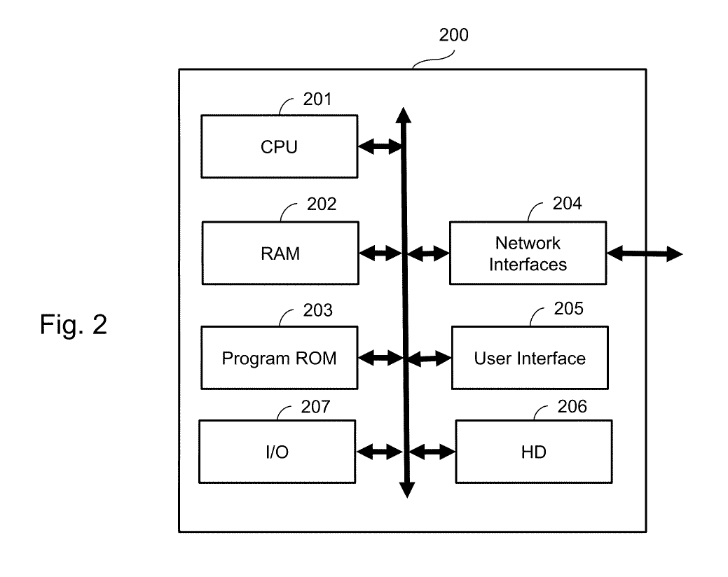

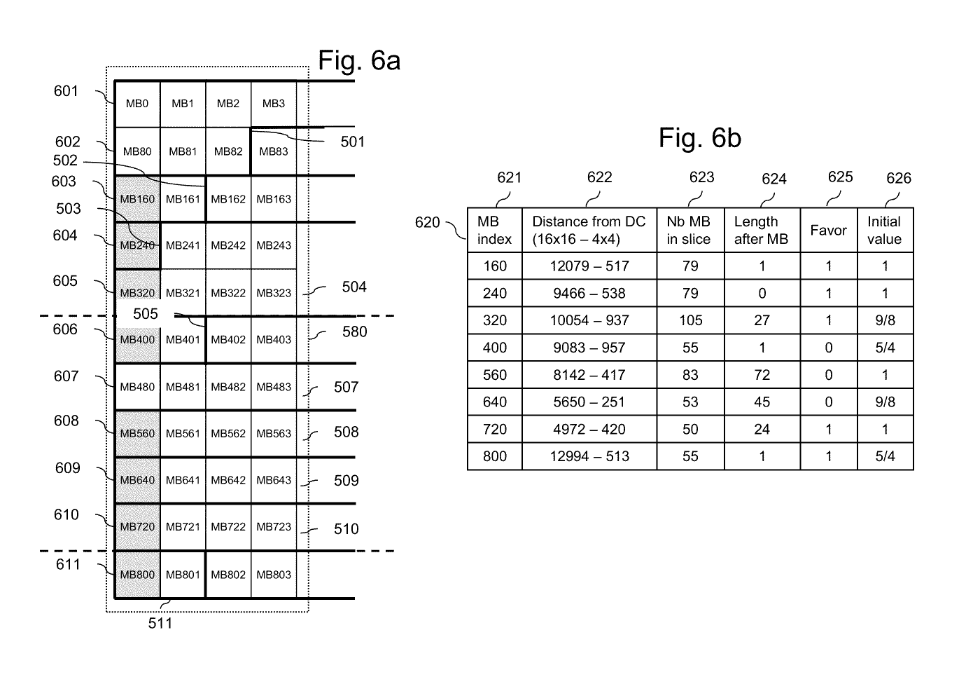

FIG. 2 is a schematic illustration of an encoding device according to embodiments. The device comprises a RAM memory 202 which may be used as a working memory for a central processing unit 201 configured for implementing a method according to embodiments. For example, the control unit may be configured to execute instructions of a computer program loaded from a ROM memory 203. The program may also be loaded from a hard drive 206. For example, the computer program is designed based on the flowcharts of FIGS. 6 to 8 and the following description.

The device also comprises a network interface 204 which may be a single network interface, or comprise a set of network interfaces (for instance several wireless interfaces, or several types of wired or wireless interfaces). Data packets are provided to the network interface for transmission or obtained from the network interface for reception under the control of the computer program executed by the control unit. The device may comprise a user interface 205 for displaying information to a user and for receiving inputs from the user.

The device may also comprise an input/output module 207 for receiving and/or sending data from/to external devices (such as video sensors, displays, etc.).

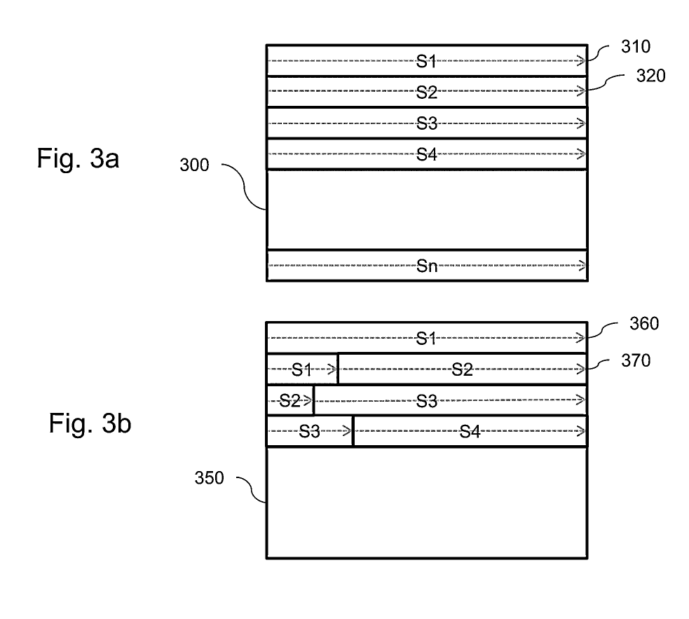

With reference to FIG. 3a, there is described a scanning scheme for encoding of a video frame (also referred to as “raster scan”) which is applied to a fixed size slicing aligned with the width of a frame 300.

A dashed arrow symbolizes the direction of the scan scheme. The scan scheme determines the order of encoding of each macroblock of the video frame. In the case of the raster scan scheme, the macroblocks are read from left to right and up to down. Each slice segment S1, S2, . . . , Sn has the same size (expressed in number of macroblocks). Slice segments 310 (S1) and 320 (S2) have the same number of macroblocks, which corresponds to the width of the video frame. In that case, each slice segment is composed of entire lines of macroblocks and corresponds to one slice.

With reference to FIG. 3b, there is described a slicing resulting from the use of a rate control adapting the size of the slice segments of a video frame 350 to the network conditions.

When using a size of slice segments (expressed in number of macroblocks) that can vary and is typically different from the width of a video frame 350, the slice segments 360 (S1) and 370 (S2) are not systematically aligned with a frame width. For instance, slice segment 360 (S1) comprises macroblocks being part of two lines of macroblocks, but does not contain all the macroblocks of these two lines of macroblocks.

The scan scheme of a video frame is described in more details in what follows.

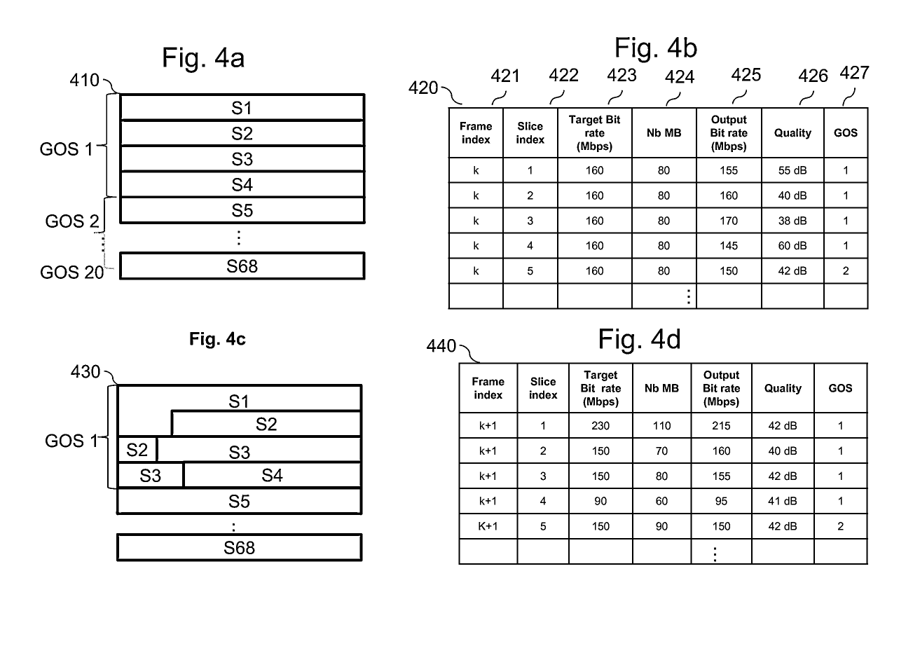

An exemplary slicing adaptation is described with reference to FIGS. 4a to 4b. Such slicing adaptation may be performed in order to improve the global quality of the encoded video frame. It may also be performed in order to maintain a pseudo constant bit rate by adapting the slice segment size to the available network bandwidth.

In FIG. 4a, a current frame 410 (with frame index k) is represented with slices before adaptation. Each slice or slice segment (S1, S2, S3, . . . , S68) comprises the same number of macroblocks corresponding to a line of macroblocks. The exemplary frame 410 has 68 slices, however any other number of slices may be used.

The slices are grouped into groups of slices (“GOS”) corresponding to slices encoded between two accesses to the network medium.

FIG. 4b is a table 420 representing encoding results after encoding the slices of frame 410. Table 420 is a part of the Slice Encoding Result Table (referred to as “SERT” in what follows).

The SERT contains a line per slice segment in a frame (e.g. 68), and seven columns 421 to 427. For the sake of conciseness, only five lines of the SERT are represented, corresponding the five first slice segments of the current frame.

Column 421 comprises the index of the frames which identifies the frames. Column 422 comprises the slice segment index in the current frame (e.g. from 1 to 68).

Column 423 comprises the target bit rate to provide to the codec for the encoding of each slice segment. In the exemplary frame 410 of FIG. 4a, to which corresponds table 420 of FIG. 4b, each slice segment (which comprises one slice in the present example) contains the same number of macroblocks. Therefore, each slice segment is encoded with the same target value. For example, the target value is equal to the average bit rate selected to encode the whole video to which belongs the current video frame. Thus, the target bit rate in column 423 is always the same for the initial slicing (i.e. before adaptation). Also, the number of macroblocks per slice segment, indicated in column 424 is always the same for the initial slicing.

Column 425 comprises the size of the bit stream resulting from the encoding of the current slice segment. Column 426 comprises the quality measurement (for example a peak signal to noise ratio, PSNR). Columns 425 and 426 give information concerning the bitstream after encoding of the slice segments.

Even though the target bit rate is always the same for all the slices, the actual bit rate obtained after encoding is slightly different from one slice segment to another. Also, quality is very different from one slice segment to another. This may be due to the fact that the slice segment complexity (from the codec point of view) may be different from one slice segment to another. Hence, a complex slice segment which has a same target bit rate than a simple slice segment, has to be compressed more than the simple slice segment. Such increase of compression decreases quality.

Column 427 of the SERT comprises the index of the GOS (Group Of Slices segment). A GOS corresponds to set of slice segments that the low latency codec is able to fully encode between two medium accesses. The GOS index corresponds to the index of the current GOS to which belongs the current slice segment.

In order to maintain a pseudo constant bit rate with constant quality, adaptation of the size of the slice segments may be performed.

FIG. 4c illustrates a frame 430 and FIG. 4d illustrates the corresponding SERT table 440.

In table 420, the third slice segment number has a bad quality (PSNR<40 db) while other have high quality (PSNR>55 db). In table 440, as compared to table 420 there are no more low quality slice segments thanks to the new macroblock repartition (or slicing).

The slices in frame 430 are not aligned with the lines of macroblocks of the frame. A slice can spread over two or more macroblock lines (e.g. S1, S2, S3). A slice can also be shorter than a macroblock line (e.g. S4).

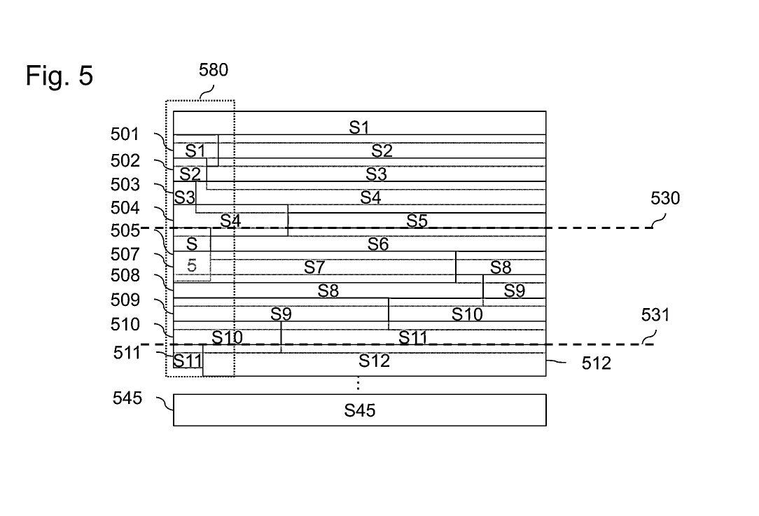

With reference to FIG. 5, there are described exemplary results of the slice segment size adaptation according to embodiments.

A video frame is divided (or segmented) into a plurality of slice segments (for example 45 slice segments, referenced from 501 to 545). The slice segments do not have the same size (namely, the slice segments do not have the same number of macroblocks). A slice segment can spread over several lines.

According to the slice segment arrangement, it is determined which macroblocks to encode with a predictor outside the slice segment to which it belongs. This will determine the type of slice segment (dependent or independent slice segment depending on the location of the predictors used).

In what follows, the macroblocks without predictors inside the slice segment are considered, except the macroblocks in the first position in the slice segments. The macroblocks considered are typically located at the left edge of the picture (area 580 in FIG. 5).

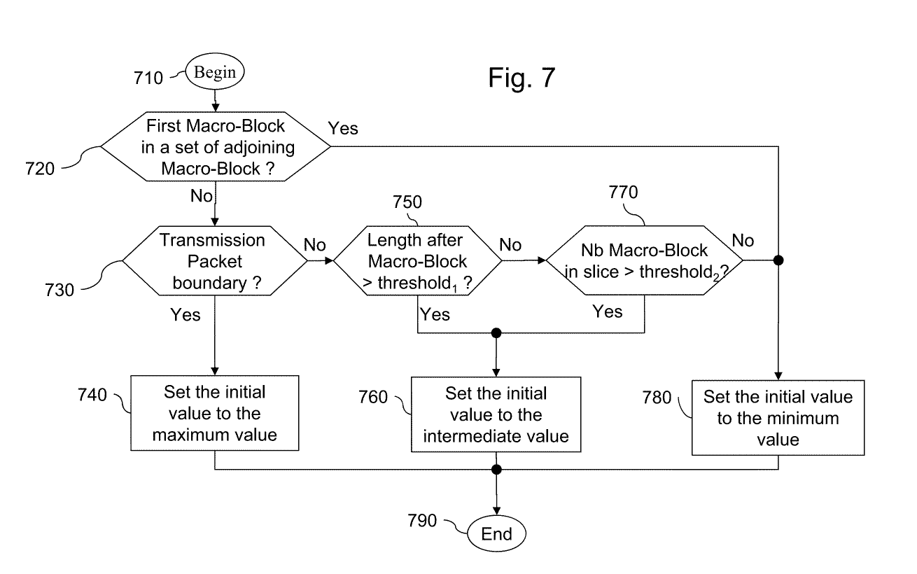

The dashed lines 530 and 531 represent the boundaries of the transmission packets. The boundaries are taken into account to compute the initial value of the limiting factor discussed herein after with reference to FIG. 6 and FIG. 7.

In what follows, with reference to FIGS. 6a and 6b, there is described the selection of macroblocks that may use predictors outside the slice segment to which they belong.

FIG. 6a is a detailed view of the area 580 in FIG. 5 showing the left edge of the frame. The bold line represents the slice boundaries.

FIG. 6b is an illustration of a table 620 comprising the macroblocks without inside predictor (the table is referred to as the “priority list” in what follows). The list may be used to select “favor macroblocks” for which the use of an outside predictor is advantageous.

The priority list may be used to define the type of the slice segment (dependent or independent slice segment) to use. When a macroblock should use an outside predictor, the slice segment to which it belongs is a dependent slice segment. Otherwise, if the slice segment does not comprise at least one macroblock of the priority list, the slice segment is an independent slice segment.

Column 621 comprises the index of the macroblocks without inside predictor except the macroblocks in first position in the slice segments. For example, macroblock 601 (MB0) and macroblock 602 (MB80) belong to the first slice segment 501 which is an independent slice segment since it cannot make any reference to a previous slice segment. Macroblock 601 (MB0) is the first macroblock of the first slice segment; it is thus excluded from the priority list. Macroblock 602 (MB80) has a surrounding macroblock inside the current slice segment, namely top macroblock 601. Macroblock 607 (MB480) is the first macroblock of slice segment 507; it is thus also excluded from the priority list. The other macroblocks in first position in the other lines 603, 604, 605, 606, 608, 609, 610 and 611 do not have any inside predictor (namely any surrounding macroblock belonging to the current slice segment). They are thus included into the priority list.

Column 622 comprises the results of the computation of the distortion between the current macroblock to encode and the DC macroblock; one outcome for each partition size (for the 16×16 block and for the first 4×4 block). In case the distortion result is low, an extra predictor may not be useful because the DC macroblock is close or is the best predictor.

Column 623 comprises the number of macroblocks in the slice segment to which belongs the current macroblock. When the number of macroblocks in a slice segment is high, this makes it possible to average the cost of an extra DC macroblock predictor.

Column 624 comprises the number of macroblocks of the current slice segment that will be encoded after the current macroblock of the priority list. These macroblocks may be encoded using the current macroblock as a predictor. Thus, this number of macroblocks represents the possible impact due to the error propagation into the slice segment. A large number of macroblocks is more critical in case of error.

Column 625 comprises the “favor” parameter. This parameter indicates the macroblocks for which the use of an outside predictor may be advantageous; the favor parameter is set to “1” for these macroblocks (the parameter is set to “0” for the others).

Column 626 indicates the initial value of a parameter referred to as the “limiting factor”. The limiting factor is used for determining whether successive dependencies should be limited during the prediction computation. The prediction computation may be carried out using a rate/distortion function for computing the cost of each predictor and thereby select the best one. For low complexity encoders, using a distortion function may be enough. According to embodiments, the limiting factor may be introduced in the prediction formula for limiting the successive dependencies. The prediction formula is thus a rate/distortion/limiting factor function (or distortion/limiting factor function for low complexity encoder). The initial value is used for the first macroblock in a set of adjoining macroblocks belonging to the priority list. A first macroblock is adjoining to a second macroblock when it is located in its direct neighborhood (at least one pixel of the first macroblock has a pixel of the second macroblock connected to its boundaries). Pixels at the boundary of the second macroblock can be used to build a predictor for the first macroblock. An initial value is computed for each macroblock of the priority list. The initial value is the effective value of the limiting factor for the first Macroblock using an outside predictor in the dependency chain. If during the process of prediction, the best prediction mode is the DC mode despite the availability of outside predictors, the dependency chain is broken and the next macroblock of the priority list becomes the first of a new set of macroblocks having adjoining relations (which use its initial value of the limiting factor).

For instance, macroblock 609 (MB640), which has a short distance from the DC macroblock uses the DC mode as best prediction choice. Next, the system resets the limiting factor by using the initial value of macroblock 610 (MB720). The macroblocks which do not belong to the priority list are set to avoid the use of outside predictors (namely, surrounding blocks outside of the dependent slice segment).

Computation of the initial value for the limiting factor is described with reference to FIG. 7 which is a flowchart of steps of an exemplary method.

The computation is initiated during a step 710. Next, it is tested whether a current macroblock is the first macroblock in a set of macroblocks having adjoining relations in the priority list. For example, macroblock 603 (MB160) and macroblock 608 (MB560) are the first macroblocks in a set of macroblocks having adjoining relations. Macroblocks 602 (MB80) and 607 (MB480) are excluded from the priority list as already explained hereinabove. If the current macroblock is the first one in a set of macroblocks having adjoining relations (Yes), the process goes to step 780. The initial value of the limiting factor is set to the minimum value. For instance, the minimum value is 1. This value does not modify the usual process of prediction mode selection.

Otherwise (No), it is checked during step 730 whether the current macroblock and its outside predictor(s) are spread over different transmission packets. In case they are spread over different transmission packets, the probability of error of transmission and therefore the probability of error propagation is increased. If the boundary between two transmission packets isolates the current macroblock from its outside predictor (like for instance macroblocks 605 and 606), the process goes to step 740 (Yes). The initial value of the limiting factor is set to the maximum value.

For instance the maximum value is set to 1.25 (i.e. 5/4). The maximum value may be defined during a learning period wherein the result for each prediction mode is analyzed and wherein a mean of the difference (called difference_{DC-best}) between the DC mode and the best prediction mode is computed. The difference_{DC-best} value represents the difference between the mean value of DC mode prediction (called meanDC) and the mean value of the best prediction mode. The maximum value of the limiting factor is then determined as: 1+(difference_{DC-best}/2×mean_{DC}). The maximum value of the limiting factor may also be a factory setting.

In case it is determined during step 730 that the current macroblock and its outside predictor(s) are not spread over different transmission packets (No), the process goes to step 750 during which it is checked whether the number of macroblocks after the current macroblock in the current slice segment (field 624—Length after MB—in the table in FIG. 6b) is below a threshold (threshold₁). For instance, threshold₁ is one third (⅓) of the number of macroblocks in a line (for example 26 for a 720p video format wherein one line is made up of 80 macroblocks). This threshold value can be determined during a learning process. It can also be factory setting.

If the length after the current macroblock is above the threshold (Yes), then the process goes to step 760. The initial value of the limiting factor is set to an intermediate value. For instance the intermediate value is set to 1.125 (9/8). The intermediate value may be determined during a learning process. It may also be a factory setting. The intermediate value may also be based on the maximum value, for example, the formula for the intermediate value may be: 1+((difference_{DC-best}/2×mean_{DC})/2).

Back to step 750, if the remaining number of macroblocks belonging to the current slice segment is below the threshold (No), the process goes to step 770.

During step 770, it is checked whether the number of macroblocks in the slice segment is greater than a second threshold (threshold2). The second threshold is, for instance, equal to the picture width (expressed in number of Macroblocks). It the number of macroblocks is greater than the threshold (Yes), the process goes to step 760. For instance, macroblock 605 (MB320) has an initial value of the limiting factor equal to 1.125. Otherwise (No), the process goes to step 780.

After the initial value of the limiting factor has been set (steps 740, 760 and 780), the process ends at step 790.

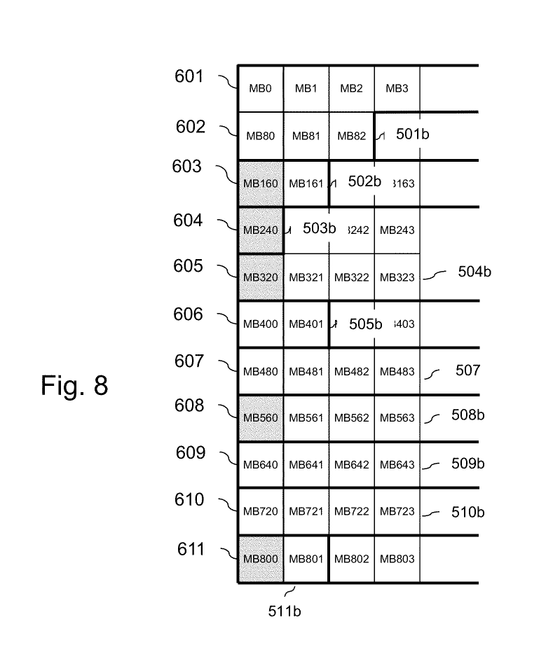

FIG. 8 is an illustration of the macroblocks of FIG. 6a using outside predictors during the encoding process. During the encoding process, due to the increase of the limiting factor value according to the length of the dependency chain, the number of macroblocks using outside predictors is smaller than the number of macroblocks in the priority list.

The first difference is for macroblock 606 for which the length of the dependency chain is high and the limiting factor imposes to use the DC mode as predictor.

The second and third differences are for macroblocks 609 and 610. In both cases, the DC predictor is used due to the small distortion introduced by this prediction mode.

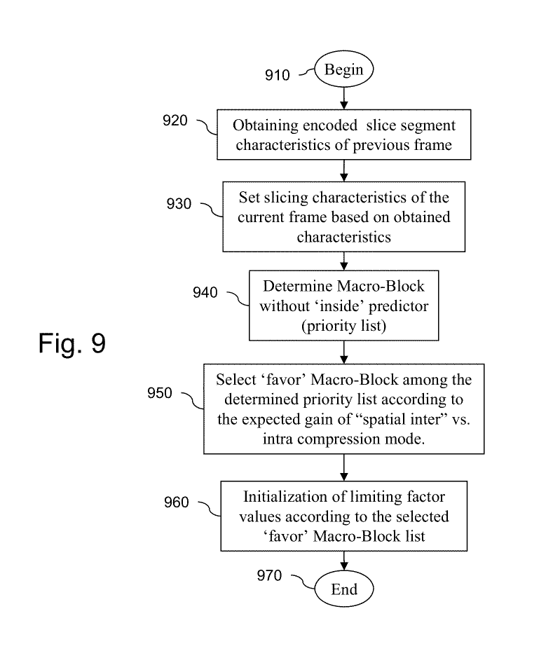

Selection of the macroblocks for which an outside predictor may be used is described with reference to FIG. 9 which is a flowchart of steps of an exemplary method.

The method is initiated at step 910. Next, the encoded slice segment characteristics of the previous frame are obtained during step 920. The characteristics comprise the size of the bitstream (output bit rate 425), the quality parameter 426, the number of macroblocks per slice segment 424. The slice segments characteristics may be used for determining, during step 930, the segmentation of the current frame into slices, i.e. the way to split the frame into slice segments or to define the slice segment boundaries (for instance as illustrated in FIG. 5).

Next, during step 940, according to the slice segment arrangement, it is determined which macroblocks only have the DC mode available as predictor mode. These macroblocks without inside predictor (i.e. a surrounding block available in the current slice as a predictor candidate) are stored in the priority list 620 for further processing.

During step 950, a filtering is performed in order to select the macroblock that can provide the best advantages (the “favor” macroblock) among the macroblocks in the priority list 620. Field 625 of table 620 is set to “1” for the favor macroblocks and is set to “0” for the other macroblocks.

For example, advantageous macroblocks may be determined based on the distortion 622 between them and the DC macroblock. When the distance is high it may be more advantageous to use another predictor. The distance or distortion may be computed by performing a Sum of Absolute Difference or other methods. The value of the distance is compared to a threshold in order to determine the favor Macroblocks in the priority list.

Other parameters or criteria may be used for selecting favor macroblocks. For instance, a number of authorized successive dependencies, the number of macroblocks of the current slice segment that will be encoded after the macroblock using the outside predictor namely “Length after MB” (column 624 in table 620), a number of macroblocks in the slice segment (column 623 in table 620) etc.

The parameters “length after MB” and “number of Macroblock in the slice segment” can also be used as extra indicators for the global cost of an extra DC predictor. The cost of an extra DC predictor may be smoothed through the other Macroblock of the slice segment and more the slice segment is big more the cost will be averaged.

The number of successive authorized dependencies (length of the dependency chain) may also be checked in order to determine whether it is consistent with the selection of the favor macroblocks. The number of successive favor macroblocks should be lower than the maximum length of the dependency chain. The number of successive authorized dependencies may be modified according to the network condition. For instance, without error transmission, the dependencies are impact free. The typical variation of loss is from 10⁻¹ (noisy channel) to 10⁻⁶ (error free transmission) and the associated variation of the maximum length of the dependency chain is from 1 to 20% of the number of lines of macroblocks. For instance, the number of lines of macroblocks is 68 in the 1080p video format, thus, the maximum length of the dependency chain variation is from 1 to 14. The maximum length of the dependency chain can also be set by the user.

Next, during step 960, initialization of the limiting factor values is performed according to the selected ‘favor’ Macroblock list. The predictor selection is thus a function of the rate, distortion and the limiting factor instead of rate/distortion only.

The process ends at step 970.

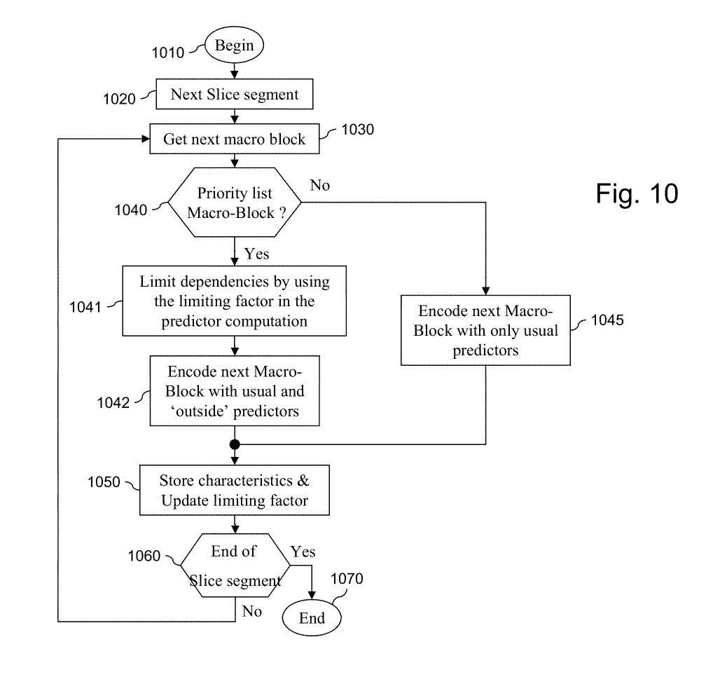

An encoding process is described with reference to FIG. 10 which is a flowchart of steps performed according to embodiments.

The encoding process starts at step 1010. During the initialization step, a variable “nb_dependency” may be created for managing the number of successive dependencies. The next slice segment to encode is then obtained during step 1020. Next, the following current macroblock is obtained during step 1030 and it is checked during step 1040 whether the current macroblock belongs to the priority list.

If the current macroblock does not belong to the priority list (No), the macroblock is encoded with an usual encoding process step 1045, i.e. with only the usual predictors (for example according to the H264 standard); the usual predictors being built with the surrounding macroblocks belonging to the current slice segment.

Otherwise (Yes), the system goes to step 1041 during which the current value of the limiting factor is given as an entry to the prediction formula according to which the best predictor is selected as a function of the rate, distortion and the limiting factor (for low complexity encoders the best predictor is selected as a function of the distortion and the limiting factor).

This is different as compared to prior art techniques wherein the prediction choice is made based on the computation of the cost of each predictor and the comparison of the cost results. The cost is either a distortion computation (distortion) or a distortion computation coupled with the number of bit required to encode the macroblock (rate/distortion).

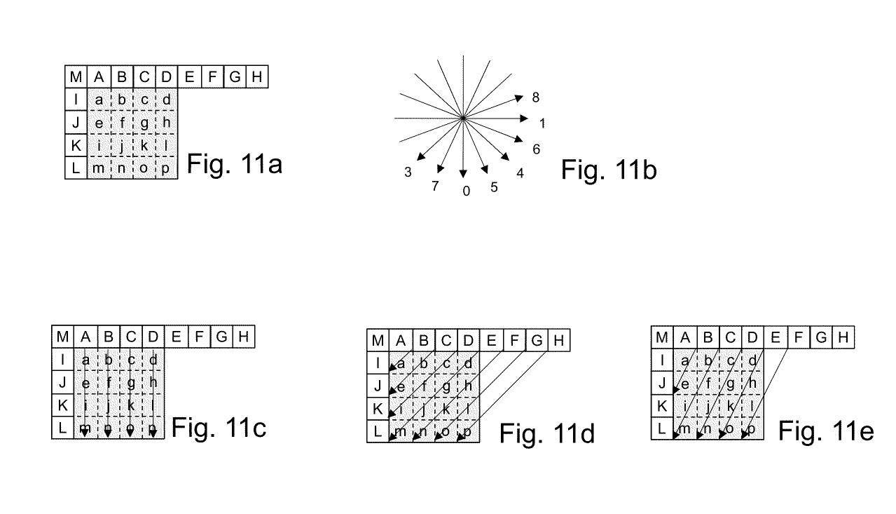

If the macroblock is in the priority list, the macroblock has only the DC as available predictor. Thus, the choice is between the DC mode and the available prediction modes outside the current slice segment; for instance, with the upper macroblocks, the vertical prediction mode (mode 0, see FIG. 11c), DC prediction mode (mode 2), DiagonalDownLeft prediction mode (mode 3, see FIG. 11d), Vertical-Left prediction mode (mode 7, see FIG. 11e). The cost formula for the mode 0, 3 and 7 is updated to take into account the limiting factor for instance cost=distortion×limiting factor.

Next, the system encodes the current Macroblock during step 1042. The encoding process comprises: the prediction, the transformation/quantization and the entropy coding. Only, the prediction step is impacted by the limiting factor, the other steps are following the standard process.

At the end of step 1042 or 1045, the system performs step 1050 wherein the characteristics of the encoded macroblock are stored in order to be used for the slice segment arrangement processing. During step 1050, the system also updates the limiting factor and the number of the successive dependencies in between intra slice segments i.e. adds 1 to the current value of the variable nb_dependency if an outside predictor is used otherwise nb_dependency resets the value to 0.

The limiting factor is set to the initial value for the next block if the dependencies chain is reset (a DC predictor is used or the previous block does not belong to the priority list). Otherwise, the limiting factor is updated. For instance, if the maximum number of dependencies is 4 (as explained previously, this value can change according to the network condition), the system adds ¼ to the current value of the limiting factor. Thus, for the fourth dependency, the distortion of the outside predictor should be 4 times smaller than the distortion of the DC predictor in order to be chosen.

Next, it is tested during step 1060 whether the end of the slice segment is reached. If the end of the slice segment is reached (Yes), the system ends at step 1070. Otherwise (No), the system goes back to the step 1030 to gets a new Macroblock to encode.

FIGS. 11a-11e illustrate the prediction directions for the 4×4 blocks as described in the H264 standard.

FIG. 11a shows the pixels that can be used as predictors (pixels A to M) for the pixels (a to p) of the 4×4 blocks to be encoded.

FIG. 11b shows the available H264 prediction modes, each mode corresponding to a prediction direction showed in FIG. 11c. Mode 2 corresponds to the DC mode and is not represented. For mode 2, the DC value is a mean value calculated from the pixels A to D and I to L if the neighboring pixels (A to M) are available. Otherwise, mode 2 is a default macroblock.

Three examples of application of the prediction direction are illustrated in FIG. 11c for the vertical prediction mode (mode 0), FIG. 11d for the Diagonal Down-Left prediction mode (mode 3) and FIG. 11e for the Vertical-Left prediction mode (mode 7). The arrows indicate the direction of propagation of the predictor pixel value.

In view of the above, according to embodiments of the invention, it is made possible to reduce the loss of encoding efficiency due to the encoding of macroblocks located at the beginning of a line of macroblocks. Use of a predictor obtained from macroblocks outside of the current slice is allowed even for the intra compression (dependent slice segments). However, use of such predictor is depending on the assessment of the risk of error propagation in the prediction chain between dependent slice segments.

According to embodiments, during the encoding of a macroblock in a slice, the encoder may test whether for a current macroblock, only the DC macroblock is available as a predictor candidate or whether there are other predictor candidates. For example, in case the macroblock has only the DC macroblock available as a predictor, the encoder checks whether the number of successive dependencies between INTRA dependent slice segments reaches a maximum threshold. If the maximum is reached, the encoder uses the DC macroblock as a predictor in order to break the dependency chain. If the maximum is not reached, the encoder uses predictor candidates obtained from its surrounding macroblocks (even outside of the dependent slice segment boundaries). The encoder also selects the best predictor among the DC macroblock and the outside predictor candidates (i.e. prediction modes pointing to surrounding blocks outside the dependent slice segment).

After having selected a predictor, the encoder may update the number of successive dependencies between intra slices, for example by adding 1 to the current values if an outside predictor is used or resets the value to 0.

The decision of using outside predictors can be made based on several criteria such as network conditions, the position of the current macroblock in the dependent slice segment, the expected benefit associated with the use of outside predictors, the packetization, etc. Also, a pre-choice of the macroblocks which use the outside predictor may be done based on the slice repartition of the previous frame.

As shown hereinabove, error propagation is reduced when using dependent slices in networks wherein transmission errors are likely to occur, such as wireless networks. The dependent slices are used to avoid loss of quality after encoding (while keeping the same bit stream size), when using a control rate based on the slice size adaptation.

Prediction of macroblock may be dynamically adapted according to the risk of error propagation (network conditions, number of successive dependencies, etc.).

While the invention has been illustrated and described in detail in the drawings and foregoing description, such illustration and description are to be considered illustrative or exemplary and not restrictive, the invention being not restricted to the disclosed embodiment. Other variations to the disclosed embodiment can be understood and effected by those skilled in the art in practicing the claimed invention, from a study of the drawings, the disclosure and the appended claims.

In the claims, the word “comprising” does not exclude other elements or steps, and the indefinite article “a” or “an” does not exclude a plurality. A single processor or other unit may fulfill the functions of several items recited in the claims. The mere fact that different features are recited in mutually different dependent claims does not indicate that a combination of these features cannot be advantageously used. Any reference signs in the claims should not be construed as limiting the scope of the invention.

1. A method of processing data for video encoding, the method comprising the following steps:
obtaining a current coding entity of a current video frame to encode, said current frame to encode being segmented according to a plurality of coding entities, each coding entity comprising a plurality of coding units, and
for a current coding unit of the current coding entity obtained:
determining whether there are neighbouring pixels outside the current coding entity that can be used for generating an outside coding unit predictor for predicting said current coding unit,
enabling, based on a result of said determining step, use of neighbouring pixels outside the current coding entity, for generating at least one outside coding unit predictor for predicting the current coding unit, and
selecting, using at least one weighting criterion applied to the at least one outside coding unit predictor, a coding unit predictor among a default coding unit and the at least one outside coding unit predictor.

2. A method according to claim 1, wherein said weighting criterion is based on a risk of propagating errors using an outside coding unit predictor as a predictor for the current coding unit.

3. A method according to claim 1, wherein said weighting criterion is based on at least one of:
a dependency chain length measuring successive dependencies between coding entities for the current coding entity,
transmission conditions in a network to be used for transmitting the current coding entity,
a length of the current coding entity after the current coding unit,
a length of the current coding entity, and
a comparison value, measuring a difference between the current coding unit and said default coding unit.

4. A method according to claim 1, further comprising the following steps:
computing for each coding unit of the coding entities of the current video frame, a dependency parameter value, said dependency parameter representing a risk of error propagation induced by the use of outside coding unit predictors for each coding units, and
for each coding unit, deciding, based on said value, to discard use of outside coding units as predictors for each coding unit.

5. A method according to claim 4, further comprising updating said dependency parameter value, based on whether a default coding unit or an outside coding unit predictor is used as a predictor for the current coding unit.

6. A method according to claim 4, further comprising an initialization step for initializing the dependency parameters for the coding units of the coding entities of the current frame, said initializing step comprising:
determining whether the current coding unit and a neighbouring pixels outside the current coding entity belong to respective distinct transmission packets, and
setting the dependency parameter of a current coding unit to a maximum initial value indicating that error propagation in case of use of said outside coding unit as a predictor for the current coding unit is high.

7. A method according to claim 4, further comprising an initialization step for initializing the dependency parameters for the coding units of the coding entities of the current frame, said initializing step comprising:
determining whether the current coding unit and an outside coding unit belong to separate transmission packets,
determining whether a length of the current coding entity after the current coding unit is above a first threshold, and
setting the dependency parameter of a current coding unit to an intermediate initial value indicating that error propagation in case of use of said outside coding unit as predictor for the current coding unit is average.

8. A method according to claim 7, further comprising wherein said initializing step further comprises:
determining whether a length of the current coding entity is above a second threshold, and
setting the dependency parameter of a current coding unit to an intermediate initial value indicating that error propagation in case of use of said outside coding unit as a predictor for the current coding unit is average.

9. A method according to claim 4, further comprising an initialization step for initializing the dependency parameters for the coding units of the coding entities of the current frame, said initializing step comprising:
determining whether the current coding unit is a first coding unit in a set of coding units having adjoining relations, and
setting the dependency parameter of a current coding unit to a minimum initial value indicating that error propagation in case of use of said outside coding unit as a predictor for the current coding unit is low.

10. A method according to claim 1, further comprising the following steps, performed for each coding unit of the coding entities of the current video frame:
comparing a first difference between the current coding unit and said default coding unit with at least one second difference between the current coding unit and an outside coding unit predictor, and
computing a favour parameter value, said favour parameter indicating whether an outside coding unit may be used as a better predictor than the default coding unit, based on said comparing step.

11. A method according to claim 10, further comprising a step of filtering coding units according to their respective favour parameter values, and wherein the initialization step according to any one of claims 4 to 9 is performed for coding units for which an outside coding unit may be used as a better predictor than the default coding unit.

12. A method according to claim 1, further comprising a step of generating a list of coding units of the frame to encode, the coding units of the list not having any neighbouring pixels of the same coding entity to use for generating a predictor, and wherein the step of determining whether an outside coding unit of the current coding entity can be used as a predictor is based on said list.

13. A method according to claim 12, wherein said list comprises, for each coding unit of the list at least one of:
a length of the current coding entity after the current coding unit,
a length of the current coding entity,
a comparison value, measuring a difference between the current coding unit and said default coding unit,
a dependency parameter value, and
a favour value.

14. A method according to claim 1, further comprising determining a type of the current coding entity, based on the coding unit predictors selected for predicting the coding units of the current coding entity.

15. A method according to claim 14, wherein the current coding entity is a slice segment, said slice segment being of the independent type in case no coding unit of the slice segment is predicted by an outside coding unit predictor.

16. A device for processing data for video encoding, the device comprising a processing unit configured for obtaining a current coding entity of a current video frame to encode, said current frame to encode being segmented according to a plurality of coding entities, each coding entity comprising a plurality of coding units, and, for a current coding unit of the current coding entity obtained, the processing unit being further configured for determining whether there are neighbouring pixels outside the current coding entity that can be used for generating an outside coding unit predictor for predicting said current coding unit, enabling, based on a result of said determining step, use of neighbouring pixels outside the current coding entity, for generating at least one outside coding unit predictor for predicting the current coding unit, and selecting, using at least one weighting criterion applied to the at least one outside coding unit predictor, a coding unit predictor among a default coding unit and the at least one outside coding unit predictor.

17. A non-transitory information storage means readable by a computer or a microprocessor storing instructions of a computer program, for implementing a method according to claim 1, when the program is loaded and executed by the computer or microprocessor.
